(19) United States
(12) Patent Application Publication
(10) Pub. No.: US 2026/0137597 A1
(43) Pub. Date: May 21, 2026

(54) INFANT BOTTLE NIPPLE

(71) Applicant: REMastered Sleep LLC, Eagan, MN (US)

(72) Inventors: Will Schneider, Foley, MN (US); Anders Leif Olmanson, Eagan, MN (US); Michael Bucaro, Arlington Heights, IL (US); Jim Haase, Maplewood, MN (US)

(21) Appl. No.: 19/395,523

(22) Filed: Nov. 20, 2025

Related U.S. Application Data
(60) Provisional application No. 63/723,088, filed on Nov. 20, 2024.

(51) Int. Cl. A61J 11/00; A61J 11/02; A61J 11/04

(52) U.S. Cl. CPC A61J 11/002; A61J 11/0015; A61J 11/005; A61J 11/006; A61J 11/02; A61J 11/045

(57) ABSTRACT

A baby bottle nipple including a flexible nipple body, a nipple tip, and a valve. The flexible nipple body has a body wall. The nipple tip has a tip wall that is more rigid than the body wall, a lumen defined through the nipple tip, and an opening disposed at a distal end of the nipple tip, the opening in fluidic communication with the lumen. The valve is disposed within the lumen such that the valve is disposed between an interior of the nipple body and the opening, and the valve has a closed configuration and an open configuration. The valve has a threshold cracking pressure to regulate flow, such that a non-negligible pressure differential is required to urge the valve into the open configuration.

### CROSS-REFERENCE TO RELATED APPLICATION(S)

This application claims the benefit under 35 U.S.C. § 119(e) to U.S. Provisional Application 63/723,088, filed Nov. 20, 2024 and entitled “Improved Infant Bottle Nipple and Related Methods,” which is hereby incorporated herein by reference in its entirety.

### FIELD

The various embodiments herein relate to infant bottle nipples and related methods.

### BACKGROUND

It is well established that breastfeeding is ideal for both the mother and the infant. For the infant, one such benefit is proper oral development. However, many mothers are not able to breastfeed their children, causing them to turn to baby bottles as a secondary means of feeding their children.

One disadvantage of known baby bottles is that they are typically not designed with oral and airway development in mind. For example, most infant bottles regulate flow with either a simple hole or a short tube, but the flow profile characteristic of this type of regulator has been shown to allow improper and insufficient use of the tongue and airway muscles during feeding, which may lead to a multitude of long-term health issues.

Another disadvantage of known baby bottles is an overly rigid nipple, which prevents the nipple from deforming to the baby's mouth like a breast would. This can have a negative effect on the latch, the suck-swallow-breathe cycle, and the orofacial development of the baby.

There is a need in the art for an improved infant bottle nipple that can provide the same or similar developmental benefits as breast feeding.

### BRIEF SUMMARY

Discussed herein are various embodiments relating to infant bottle nipples. A baby bottle nipple includes a flexible nipple body, a nipple tip, and a valve. The valve has a threshold cracking pressure to regulate flow, such that a non-negligible pressure differential is required to urge the valve into the open configuration.

Devices and methods described herein can improve the simulation of breastfeeding using an infant bottle. For example, the devices described herein can regulate the flow of liquid such that the flow of liquid (of lack thereof) influences an infant's behavior, promoting use of the bottle nipple in a same or similar manner to breastfeeding. The infant bottle nipple body can be a pliable material and the nipple tip can be firmer than the nipple body, which can promote latching thereon by an infant. Additionally or alternatively, the devices described herein can be engaged by an infant's jaw and/or tongue in a same or similar manner to that of breastfeeding. Devices described herein can include various features and/or configurations to prevent misuse of the baby bottle nipple.

In Example 1, a baby bottle nipple comprises a flexible nipple body comprising a body wall; a nipple tip comprising: a tip wall that is more rigid than the body wall; a lumen defined through the nipple tip; and an opening disposed at a distal end of the nipple tip, the opening in fluidic communication with the lumen; and a valve disposed within the lumen such that the valve is disposed between an interior of the nipple body and the opening, wherein the valve comprises a closed configuration and an open configuration, wherein the valve has a threshold cracking pressure to regulate flow, such that a non-negligible pressure differential is required to urge the valve into the open configuration.
Example 2 relates to the baby bottle nipple according to Example 1, wherein the valve comprises a thin diaphragm having a slit.
Example 3 relates to the baby bottle nipple according to Example 1, wherein the nipple body and the nipple tip are configured to simulate the shape, structure and consistency of a human breast.
Example 4 relates to the baby bottle nipple according to Example 1, wherein the nipple body is configured to be pliable and stretchy such that the nipple body deforms between a roof of a baby's mouth, gums and tongue when a suction is applied thereto.
Example 5 relates to the baby bottle nipple according to Example 1, the body wall comprises: a proximal section having a proximal section thickness, an intermediate section having a an intermediate section thickness, and a distal section having a distal section thickness, wherein the proximal section thickness is greater than the intermediate section thickness, and wherein the proximal section is configured to be latched onto by a baby.
Example 6 relates to the baby bottle nipple according to Example 5, wherein the proximal section thickness ranges from about 1 mm to about 3 mm.
Example 7 relates to the baby bottle nipple according to Example 5, wherein the intermediate section thickness is less than 1 mm.
Example 8 relates to the baby bottle nipple according to Example 5, wherein the distal section thickness ranges from about 2 mm to about 5 mm.
Example 9 relates to the baby bottle nipple according to Example 5, wherein the nipple tip is disposed at the distal section of the body wall, and wherein the tip wall has a tip wall thickness ranging from about 1 mm to about 5 mm.
Example 10 relates to a baby bottle nipple comprising a nipple body comprising a flexible body wall; a nipple tip comprising: a first end; a second end opposite the first end; and a tip wall forming a cavity extending from the first end to the second end, and a valve disposed within the cavity, the valve having an open configuration and a closed configuration, wherein, in response to a non-negligible threshold pressure being applied to the valve by a mouth of a user, the valve is configured to move from the closed configuration into the open configuration.
Example 11 relates to the baby bottle nipple according to Example 10, wherein the nipple body comprises a latching section configured for a user to latch onto during use, the nipple tip is disposed on a distal end of the nipple body, and when a user latches onto the latching section, the distal end of the nipple body is configured to be positioned in the user's mouth.
Example 12 relates to the baby bottle nipple according to Example 11, wherein the nipple tip has a length ranging from about 5 mm to about 15 mm.
Example 13 relates to the baby bottle nipple according to Example 11, wherein the latching section has a wall thickness of about 0.5 mm to about 3 mm, and wherein the nipple tip has a tip wall thickness of about 1 mm to about 5 mm.
Example 14 relates to the baby bottle nipple according to Example 10, wherein the cavity extends from the first end of the nipple tip to the second end of the nipple tip, and wherein the valve is disposed in the cavity closer to the first end of the nipple tip than to the second end of the nipple tip.
Example 15 relates to the baby bottle nipple according to Example 14, wherein the valve is configured to remain in the closed configuration when the tip wall is compressed by the user.
Example 16 relates to a baby bottle comprising a bottle body comprising a wall, the wall forming a bottle body cavity configured to receive a liquid; a bottle nipple comprising: a nipple body comprising a flexible body wall; a nipple tip comprising: a proximal end; a distal end having an opening; and a tip wall forming a tip cavity extending from the proximal end to the distal end, the tip cavity being in fluidic communication with the bottle body cavity and the opening, and a valve disposed within the tip cavity, the valve having an open configuration and a closed configuration, wherein the bottle nipple is operably coupled to the bottle body, wherein, in response to a non-negligible threshold pressure being applied to the valve by a user, the valve is configured to move from the closed configuration into the open configuration, and wherein the open configuration of the valve is configured to permit a flow of liquid from the bottle body cavity and through the tip cavity.
Example 17 relates to the baby bottle nipple according to Example 16, wherein the nipple body is configured to be pliable and stretchy such that the nipple body deforms between a roof of a baby's mouth, gums and tongue when a suction is applied thereto by said baby.
Example 18 relates to the baby bottle nipple according to Example 16, wherein the nipple body comprises a latching section, and wherein the flexible body wall has a thickness ranging from about 1 mm to about 3 mm at the latching section.
Example 19 relates to the baby bottle nipple according to Example 16, wherein, in response to the nipple tip being compressed by a user, the tip wall is configured to be compressed at the opening and the valve is configured to remain in the closed configuration.
Example 20 relates to the baby bottle nipple according to Example 16, wherein the valve is disposed in the tip cavity closer to the proximal end of the nipple tip than to the distal end of the nipple tip.

While multiple embodiments are disclosed, still other embodiments will become apparent to those skilled in the art from the following detailed description, which shows and describes illustrative embodiments. As will be realized, the various implementations are capable of modifications in various obvious aspects, all without departing from the spirit and scope thereof. Accordingly, the drawings and detailed description are to be regarded as illustrative in nature and not restrictive.

### BRIEF DESCRIPTION OF THE DRAWINGS

The following drawings are illustrative of particular examples of the various embodiments contemplated herein and therefore do not limit the scope thereof. The drawings are not necessarily to scale, though embodiments can include the scale illustrated, and are intended for use in conjunction with the explanations in the following detailed description wherein like reference characters denote like elements. Examples will hereinafter be described in conjunction with the appended drawings.

FIG. 1A is a perspective view of an infant bottle having an improved infant bottle nipple, according to one embodiment.

FIG. 1B is a side cross-section view of the infant bottle of FIG. 1A, according to one embodiment.

FIG. 1C is a perspective view of a nipple tip of the infant bottle of FIG. 1A.

FIG. 1D is a side view of an example valve of the infant bottle tip of FIG. 1A in a closed configuration.

FIG. 1E is a side view of the example valve of FIG. 1D in an open configuration.

FIG. 2A is a schematic view of an example infant bottle during use, according to one embodiment.

FIG. 2B is a schematic view of an example infant bottle during a swallow, according to one embodiment.

FIG. 3 is depicts graphical representation of a change in flow rate of liquid through an infant bottle nipple, according to one embodiment.

FIG. 4A is a side view of a valve of an improved infant bottle nipple in a closed configuration, according to one embodiment.

FIG. 4B is a side view of another valve of an improved infant bottle nipple in an open configuration, according to one embodiment.

FIG. 5 is a side view of another valve of an improved infant bottle nipple in a closed configuration, according to one embodiment.

FIG. 6 is a side view of another valve of an improved infant bottle nipple in a closed configuration, according to one embodiment.

FIG. 7 is a side view of another valve of an improved infant bottle nipple in a closed configuration, according to one embodiment.

FIG. 8 is a side view of another valve of an improved infant bottle nipple in a closed configuration, according to one embodiment.

FIG. 9 is side cross-section view of a reinforced nipple tip, according to one embodiment.

FIG. 10A is a side cross-section view of a ring of a reinforced nipple tip, according to one embodiment.

FIG. 10B is a cross-section view of a ring of another reinforced nipple tip, according to one embodiment.

FIG. 10C is a cross-section view of a ring of another reinforced nipple tip, according to one embodiment.

FIG. 10D is a cross-section view of a ring of another reinforced nipple tip, according to one embodiment.

FIG. 10E is a cross-section view of a ring of another reinforced nipple tip, according to one embodiment.

FIG. 11A is a cross-section view of a lumen of a nipple tip, according to one embodiment.

FIG. 11B is a cross-section view of another lumen of a nipple tip, according to one embodiment.

FIG. 11C is a cross-section view of another lumen of a nipple tip, according to one embodiment.

FIG. 11D is a cross-section view of another lumen of a nipple tip, according to one embodiment.

FIG. 12A is a perspective view of another embodiment of a of an infant bottle having an improved infant bottle nipple, according to one embodiment.

FIG. 12B is a side cross-section view of the infant bottle of FIG. 12A, according to one embodiment.

FIG. 13A is a perspective view of another embodiment of a of an infant bottle having an improved infant bottle nipple, according to one embodiment.

FIG. 13B is a side cross-section view of the infant bottle of FIG. 13A, according to one embodiment.

FIG. 14A is a side cross-section view an attachment configuration of an infant bottle nipple to an infant bottle, according to one embodiment.

FIG. 14B is a side cross-section view another attachment configuration of an infant bottle nipple to an infant bottle, according to one embodiment.

FIG. 14C is a side cross-section view another attachment configuration of an infant bottle nipple to an infant bottle, according to one embodiment.

FIG. 14D is a cross-section view another attachment configuration of an infant bottle nipple to an infant bottle, according to one embodiment.

FIG. 15A is a side cross-section view an attachment configuration of an infant bottle nipple to an infant bottle, according to one embodiment.

FIG. 15B is a side cross-section view another attachment configuration of an infant bottle nipple to an infant bottle, according to one embodiment.

FIG. 15C is a side cross-section view another attachment configuration of an infant bottle nipple to an infant bottle, according to one embodiment.

FIG. 15D is a side cross-section view another attachment configuration of an infant bottle nipple to an infant bottle, according to one embodiment.

FIG. 16A is a side view of another embodiment of an infant bottle nipple, according to one embodiment.

FIG. 16B is a side view of the embodiment of FIG. 16A in an extended configuration, according to one embodiment.

FIG. 17A is a side view of an embodiment of a nipple tip, according to one embodiment.

FIG. 17B is a side view of another embodiment of a nipple tip, according to one embodiment.

FIG. 17C is a side view of another embodiment of a nipple tip, according to one embodiment.

FIG. 17D is a side view of another embodiment of a nipple tip, according to one embodiment.

FIG. 18A is a top view of a another embodiment of a nipple tip, according to one embodiment.

FIG. 18B is a top view of an embodiment of a nipple tip, according to one embodiment.

FIG. 19A is a cross-section side view of an embodiment of an infant bottle nipple, according to one embodiment.

FIG. 19B is a cross-section side view of another embodiment of an infant bottle nipple, according to one embodiment.

FIG. 20A is an embodiment of an umbrella valve of an infant bottle nipple tip, according to one embodiment.

FIG. 20B is an embodiment of a slit valve of an infant bottle nipple tip, according to one embodiment.

FIG. 21A is a perspective view of another embodiment of an infant bottle nipple tip, according to one embodiment.

FIG. 21B is a side cross-section view of the embodiment of FIG. 21A, according to one embodiment.

FIG. 22A is a top view of another embodiment of a bottle nipple including a slit, according to one embodiment.

FIG. 22B is a side cross-section view of the nipple tip of FIG. 19A, according to one embodiment.

FIG. 22C is side cross-section view of another embodiment of the nipple tip of FIG. 19A, according to one embodiment.

FIG. 23A is a bottom view of an infant bottle nipple, according to one embodiment.

FIG. 23B is a cross-sectional side view of the infant bottle nipple of FIG. 23A, according to one embodiment.

### DETAILED DESCRIPTION

The various embodiments herein relate to a baby bottle nipple having a valve system with a non-zero opening pressure that results in a system of flow regulation. The non-zero opening pressure replicates that of the human breast, thereby causing flow to stop during the swallow cycle of the baby (thereby preventing aspiration) and requiring the infant to provide a suction similar to that required by the breast. Thus, the various nipple implementations herein are configured to encourages babies to feed as they would at the breast by removing means of misuse common with other nipples/bottles.

Further, in certain embodiments, the nipple is soft, stretchy and/or deformable, allowing the nipple to deform to the baby's mouth more similarly to a breast in comparison to known bottle nipples. This allows for a more natural latch of the nipple by the baby, thereby causing the engagement of facial muscles more similar to breastfeeding. Additionally, it will promote intraoral compression forces that are relatively even across the palate, require proper jaw movement and muscle engagement, and allow the baby to use the same or similar techniques and patterns to which the baby is accustomed to using at the breast.

The various embodiments described herein can promote rhythmic opening and closing of a mandible of an infant combined with a protrusion-retraction motion of the mandible. Mandibular opening and closing can be characterized by depression and elevation of the mandible (i.e., the infant jaw opening and closing), and mandibular protrusion-retraction can be characterized as a suckling motion that generates negative pressure, allowing an infant to draw liquid therefrom. The mandibular protrusion-retraction can be a piston-like suckling motion.

Depression and elevation of the mandible can engage various muscles of the user. Opening of the jaw, or depression of the jaw, can be characterized by engagement of the anterior belly of digastric, mylohyoid, and geniohyoid (suprahyoid) muscles, with assistance from lateral pterygoid muscles; these muscles can be stabilized by infrahyoid muscles. Closing of the jaw, or elevation of the jaw, is characterized by engagement of the masseter, temporalis, and medial pterygoid muscles.

Additionally or alternatively, other muscles may engaged to support sealing and/or pressure applied by the infant. An infant may engage their lips, cheeks, and/or tongue muscles to express milk and/or maintain suction. This can include engagement of the orbicularis oris, buccinator, and/or genioglossus, styloglossus, and intrinsic tongue muscles. Some or all of these muscles may be engaged when an infant drinks from the embodiments described herein.

Misuse may be characterized as deviation from breastfeeding mechanics. This may include a change in intraoral kinematics, including deviation from tongue and/or jaw motions associated with breastfeeding. Reduction of forces and/or muscle engagement during feeding may also constitute misuse. This includes a reduction of forces creating an intra-oral vacuum (i.e., suction forces), which can be combined with a rolling tongue wave motion. Additionally or alternatively, reduction in the magnitude and force associated with jaw/tongue movements can constitute misuse, as such a reduction can alter muscle engagement. For example, during breastfeeding, infants may experience larger mandibular displacement and greater overall jaw activity when compared to bottle feeding with known bottle nipples; bottle feeding may result in smaller excursions, reduced masseter activity, and/or increased buccinator and/or mentalis use when compared to breastfeeding. Thus, breastfeeding engages a different orofacial movement pattern than the orofacial movement pattern engaged during bottle feeding.

Additionally or alternatively, the suck-swallow-breath cycle associated with breastfeeding can differ from the suck-swallow-breath cycle associated with bottle feeding using known bottles. The suck-swallow-breath cycle associated with bottle feeding can include fewer and/or shorter pauses than those associated with breastfeeding, and can be associated with reduced suction when compared to breastfeeding. When compared to breastfeeding, the suck-swallow-breath cycle associated with bottle feeding may be more arrhythmic.

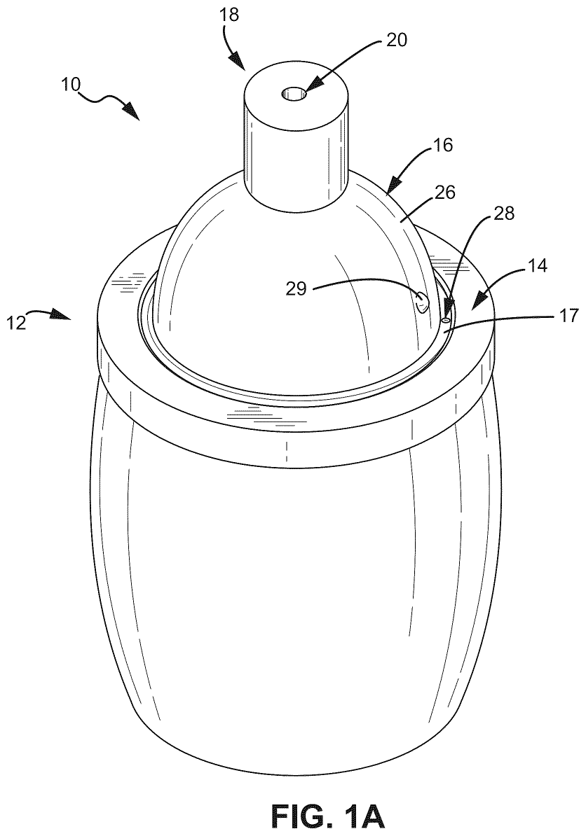

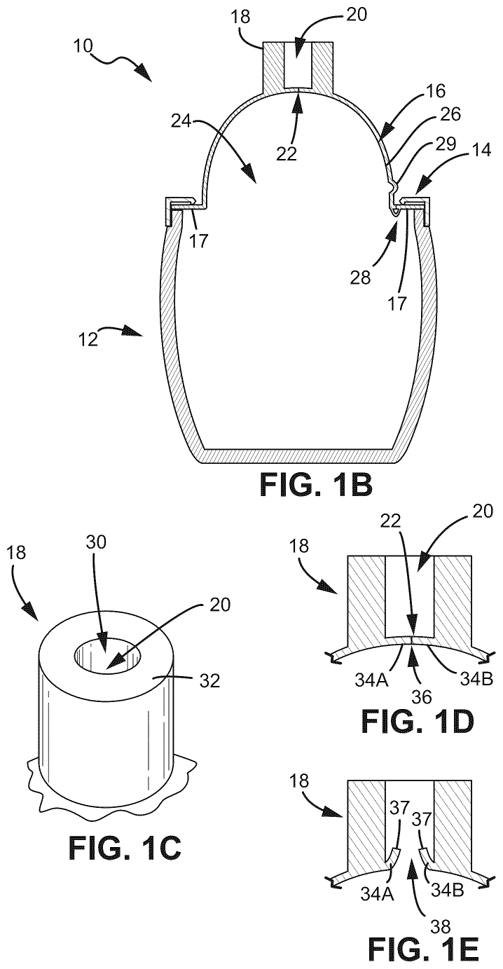

One specific baby bottle nipple embodiment is depicted in FIGS. 1A-1E. As best shown in FIG. 1A and FIG. 1B, the nipple 10 is removably coupled to a bottle 12 via a threaded cap (or “connector”) 14. The nipple 10 can be disposed between the cap 14 and the bottle 12 such that the tightening of the cap 14 to the bottle 12 via the threads results in the nipple 10 being fixedly attached therebetween as shown. The nipple 10 has a nipple body 16 including a base lip 17, a nipple tip 18 with a lumen 20 defined therethrough, and a valve 22 disposed within the lumen 20. The valve 22 has an open configuration in which the valve 22 provides fluidic communication between the interior 24 of the nipple body 16 (and bottle 12) and the exterior of the nipple 10 near or around the nipple tip 18.

In one embodiment, the wall 26 of the nipple body 16 is flexible and/or deformable. Further, the wall 26 can have a thickness ranging from about 0.5 mm to about 3 mm. In addition, the wall 26 according to certain implementations can be made of silicone having a hardness ranging from about 5 OO to about 70 A on the Shore hardness scale. Alternatively, the wall 26 can be made of any material of similar flexibility such that the nipple body 16 can deform and expand to fill the mouth of the infant and replicate the feel of the breast for the infant.

Certain alternative implementations of the nipple body 16 can have at least one pressure release valve or vent 28 to prevent pressure buildup. As shown, the vent 28 is disposed on one side of the nipple body 16 such that if the negative pressure within the bottle exceeds a certain level, the vent 28 opens to allow reduce the negative pressure by allowing air to enter through the vent 28. Alternatively, the vent 28 can be disposed anywhere on the nipple body 16. In one embodiment, the vent 28 is an off-the-shelf duckbill vent, for example. In another embodiment, the vent 28 can be a one-way or two-way valve. Alternatively, any known vent configuration can be used.

In some embodiments, the vent 28 can be positioned to serve as a visual indicator for a user or person assisting a user. In some embodiments, the vent 28 can be positioned at a location on the bottle nipple 10 such that, if viewable during use, the vent 28 indicates that the bottle is correctly oriented in a user's mouth. In some embodiments, the vent 28 can be positioned such that the vent 28 generally faces a user's nose during use. Additionally or alternatively, a color marking or structure 29 may indicate correct orientation of the bottle during use.

The nipple tip 18 is shown in additional detail in FIG. 1B, according to one implementation. The tip 18 has an opening 30 defined on the top or distal end of the tip 18 (as best shown in FIG. 1C) such that the opening 30 is in fluidic communication with the lumen 20 defined through the tip 18 as shown. In one embodiment, the wall 32 of the tip 18 can have a thickness ranging from about 1 mm to about 6 mm. According to certain implementations, the wall 32 of the tip 18 is thicker than the wall 26 of the body 16 such that the wall 32 of the tip 18 is less flexible than the wall 26 of the body 16.

In the embodiment as shown, the valve (or “diaphragm”) 22 disposed within the lumen 20 of the tip 18 is shown in additional detail in FIGS. 1C and 1D. The valve 22 has two elongate, flexible flaps or leaves 34A, 34B, with each extending from an opposite side of the lumen 20 toward each other such that the distal ends 37 of the leaves 34A, 34B are in contact with each other in the closed configuration (as best shown in FIG. 1D), thereby defining a slit 36 therebetween. Each of the leaves 34A, 34B can have a thickness ranging from about 0.4 mm to about 4 mm. In some embodiments, the thickness of each leaf can be about 2 mm. In one embodiment, the length (not shown) of the slit 36 can range from about 2 mm to about 8 mm. The length of the slit 36 can be about the width of the tip and/or lumen, or can be less than the width of the tip and/or lumen.

In use, the two leaves 34A, 34B are moveable between their closed configuration as noted above and their open configuration as best shown in FIG. 1E, in which the leaves 34A, 34B have been urged upward such that the distal ends 37 of the leaves 34A, 34B have been urged upward and away from each other, thereby resulting in an opening 38 therebetween. This urging of the two leaves 34A, 34B and thus the valve 22 into the open configuration can be accomplished by the infant applying suction to the tip 18, as will be discussed in further detail below.

Thus, by moving between its closed configuration and its open configuration in response to varying levels of suction, the valve 22 in this embodiment and the various other valve implementations disclosed or contemplated herein operate to regulate the flow of liquid through the valve 22 and the lumen 20 of the tip 18, thereby generating a characteristic flow profile that can help to replicate the flow of milk from a human breast.

In some embodiments, a person assisting an infant can assist the infant in moving the valve from its closed configuration to its open configuration. For example, the infant may require assistance in generating the required level of suction to urge the valve from the closed configuration to the open configuration. The person assisting the infant can compress the bottle 12 and/or bottle nipple 10 to promote the flow of liquid toward the nipple tip 18, which can cause the valve 22 to move from the closed configuration to the open configuration. Manual compression by a person can be used in combination with suction applied by an infant to cause the valve 22 to move from the closed configuration to the open configuration, or may be completed without suction being applied to the valve 22 by an infant.

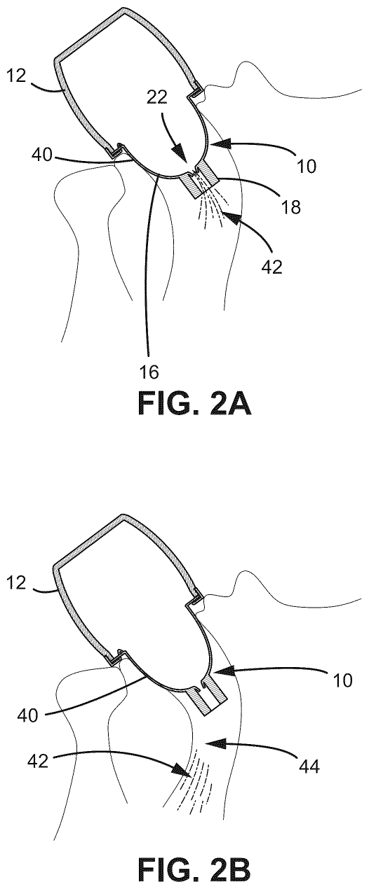

In one implementation, the nipple 10 attached to the bottle 12 can be used as shown in FIGS. 2A and 2B. In FIG. 2A, the nipple 10 is placed into the infant's mouth 40 such that the nipple body 16 can expand and deform in the interior of the mouth 40 as the infant sucks on the nipple body 16. In addition, the negative pressure created in the infant's mouth 40 causes the valve 22 to be urged into its open configuration, thereby allowing milk or formula 42 to exit the interior of the bottle 12 through the valve 22 and the nipple tip 18 and into the infant's mouth 40 as shown.

As shown in FIG. 2B, once the milk or formula 42 has entered the infant's mouth 40 and starts to move toward and into the infant's throat 44, the infant's swallow reflex will kick in, thereby causing compression of the nipple body 16 as shown. In the various nipple embodiments herein, as a result of the flexibility and easy deformability of the nipple body 16, the compression of the body 16 does not interfere with the infant's instinctive jaw movement during the swallow reflex and feels like a natural breast in the infant's mouth. Additionally, the swallow reflex causes an increase in pressure within the infant's mouth (or at least a decrease in the magnitude of negative pressure), thereby causing the valve 22 to move into the closed configuration such that the milk/formula stops flowing out of the nipple 10 and into the infant's mouth. This sucking and swallowing process can then be repeated until the infant is no longer hungry or until the bottle is empty.

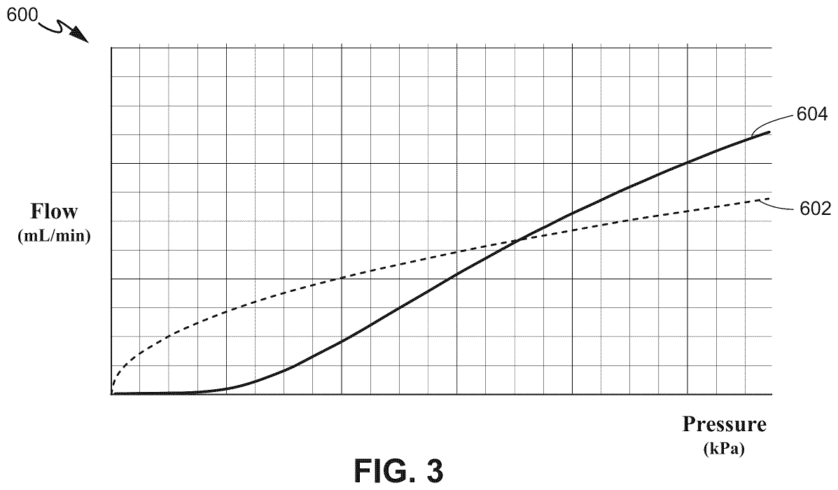

The various device embodiments herein, including device 10 as described in detail above along with the other device implementations and variations discussed in further detail below, provide a unique flow profile as described via line 604 for infants of 0 to 12 months in the graph 600 depicted in FIG. 3 (in contrast to line 602, which depicts the flow profile of a standard bottle/nipple for that same age group). One of the features of the unique flow profile is a “cracking pressure,” which is a minimum threshold of pressure that must be reached before the flow of milk/formula begins. In one embodiment, the cracking pressure or threshold at which flow occurs can range from about 0.1 kPa to about 20 kPa of negative pressure. In other embodiments, the cracking pressure or threshold at which flow occurs can range from about 4 kPa to 8 kPa. For reference, known baby bottles generally have no cracking pressure. That is, most commercially available baby bottles on the market today regulate flow via a simple hole or tube with no flow restriction. As a result, as shown in the flow profile for a standard bottle in FIG. 3 (line 602), flow is unrestricted as soon as any negative pressure (sucking) is applied to the nipple. In contrast, in the various nipple embodiments herein, a minimum threshold of negative pressure (the cracking pressure) must be applied before the nipple embodiments allow flow of milk/formula (that is, until the valve within the nipple device is urged out of its closed configuration). Thus, the negative pressure threshold of the nipple implementations disclosed or contemplated herein can reduce the risk of aspiration in the infant during the swallow and breathe portions of the cycle.

It is understood that an infant must apply a minimal base level of pressure simply to retain the nipple (of either a breast or a bottle) in the infant's mouth. Hence, the cracking pressure of the various nipple implementations herein can also help to reduce the amount of flow created solely from the minimal negative pressure applied by an infant while simply keeping the nipple in the infant's mouth.

Further, the flow regulation resulting from the valve components of the various embodiments herein results in greater milk/formula flow when the negative pressure applied by the infant is within the range of normal nursing pressures in comparison to standard nipples. That is, the simple hole or tube in a standard nipple/bottle product produces the flow profile represented by the line 602 in FIG. 3, which not only results in immediate generation of flow upon application of any negative pressure, but also results in less flow as additional negative pressure is applied in comparison to the device embodiments herein. In contrast, the various valve embodiments herein result in a higher correlation between the amount of negative pressure (suction) applied and the amount of flow produced by the suction (as shown by line 604) compared to the standard nipple (with the simple hole). In other words, as shown in the figure, the same amount of negative pressure (suction) results in greater flow in the various nipple implementations herein in comparison to known, standard nipple devices. Thus, while an infant using one of the nipple embodiments disclosed or contemplated herein is rewarded with more flow when the infant applies more suction, an infant using a standard nipple does not receive the same benefit (the additional suction does not result in the same increase in flow). Thus, the various device implementations herein incentivize increased intraoral pressures during the suck phase of the suck-swallow-breathe pattern by rewarding the infant with the increased flow, which replicates the increase in flow generated by increased suction via a breast. As a result, the target flows as suction is increased are similar to what a breastfeeding baby would expect.

Further, due to increased intraoral pressure and flow rates with age, it is expected that various device embodiments herein will be able to meet the feeding needs of a greater range of ages than conventional bottles. That is, many conventional bottles require the use of different nipples depending on the age of the infant in order to generate the desired amount of flow based on the skill and strength of the infant as the infant ages, but the various device implementations herein, with the flow profile described above, will work for several months without the need to switch nipples despite the skill and strength changes of the infant.

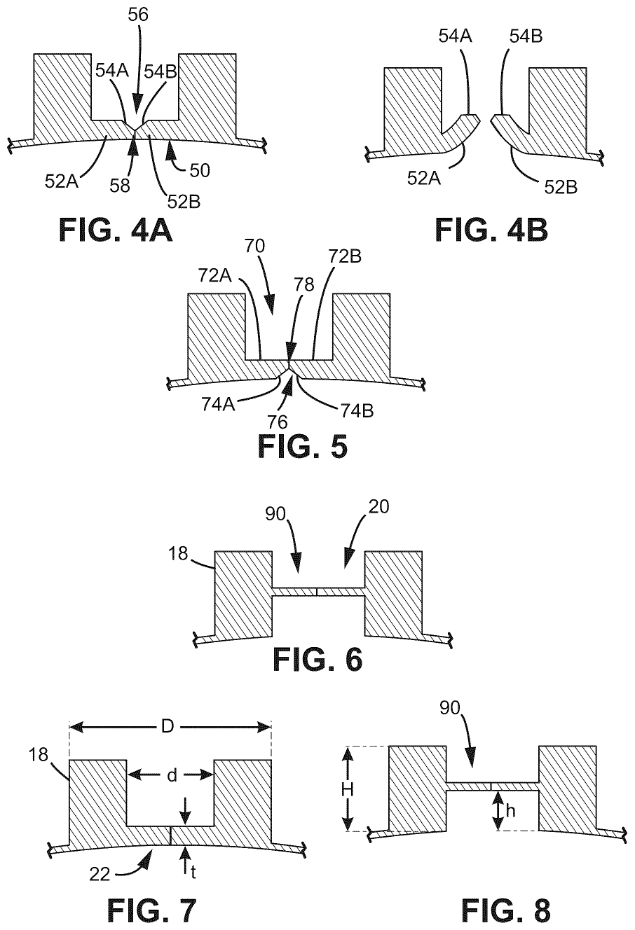

Various valve or diaphragm embodiments are depicted in FIGS. 4A-8, any of which can be incorporated into any of the device implementations disclosed or contemplated here. In FIGS. 4A and 4B, the valve 50 has two elongate, flexible flaps or leaves 52A, 52B that are substantially similar to the leaves 34A, 34B discussed above. Except as expressly discussed herein, the valve 50 and the various components thereof are substantially similar in structure and function to the valve 22 discussed above. In this specific valve 50, each leaf 52A, 52B has a notch or chamfer 54A, 54B formed at the distal end thereof. The notch 54A, 54B is formed on the top portion of the distal end of each leaf 52A, 52B as shown, thereby resulting in a recess or channel 56 formed in the top portion of the two leaves 52A, 52B at the distal ends such that the channel 56 extends across the slit 58 therebetween.

Notche(s) can reduce the contact surface between the two leaves. It may be desirable to reduce the contact surface between leaves such that the diaphragm or valve can be thicker than the distal end of each leaf, as this can prevent the leaves from obstructing movement of one another. This can improve the durability of the valve and make it easier for a user to drink therefrom. Further, the notches can introduce a variance into the flow profile, which can affect the cracking pressure needed to use the bottle nipple.

Another valve 70 implementation is shown in FIG. 5, in which the valve 70 has a recess or channel 76 formed in the bottom portion of the two leaves 72A, 72B. Except as expressly discussed herein, the valve 70 and the various components thereof are substantially similar in structure and function to the valve 22 discussed above. In this specific valve 70, each leaf 72A, 72B has a notch or chamfer 74A, 74B formed at the distal end thereof. The notch 74A, 74B is formed on the bottom portion of the distal end of each leaf 72A, 72B as shown, thereby resulting in a recess or channel 76 formed in the bottom portion of the two leaves 72A, 72B at the distal ends such that the channel 76 extends across the slit 78 therebetween.

A further valve 90 embodiment is depicted in FIG. 6. Except as expressly discussed herein, the valve 90 and the various components thereof are substantially similar in structure and function to the valve 22 discussed above. In this implementation, the valve 90 is disposed within the lumen 20 of the tip 18 such that it is disposed at some point between the proximal end and the distal end of the lumen 20 (in contrast to the valve 22, which is disposed at the proximal end of the lumen 20). In one exemplary version, the valve 90 is disposed at a point along the length of the lumen 20 that is substantially the middle of the lumen 20 (equidistant from the proximal and distal ends). Alternatively, the valve 90 can be disposed at any point along the length of the lumen 20.

The possible dimensions of the tip 18 and valve 22 will be discussed in additional detail with reference to FIG. 7, which the possible dimensions of the tip 18 and valve 90 will be discussed in additional detail with reference to FIG. 8. As shown in FIG. 7, any tip 18 embodiment herein can have an outer diameter ranging from about 4 mm to about 17 mm, while the inner diameter of the lumen 20 can range from about 0.1 mm to about 7 mm. Further, the thickness of the valve 22 and any other valve embodiment herein (including any of valves 50, 70, 90) can range from about 0.1 mm to about 4 mm. Further, as shown in FIG. 8, the location of the valve 90 within the lumen 20 can also discussed in relation to the total height (“H”) of the lumen 20 and the height (“h”) of the valve 90 within the lumen 20. In that context, the height (h) of the valve 90 within the lumen 20 can range from about 0 to about H (minus the thickness (t) of the valve 90).

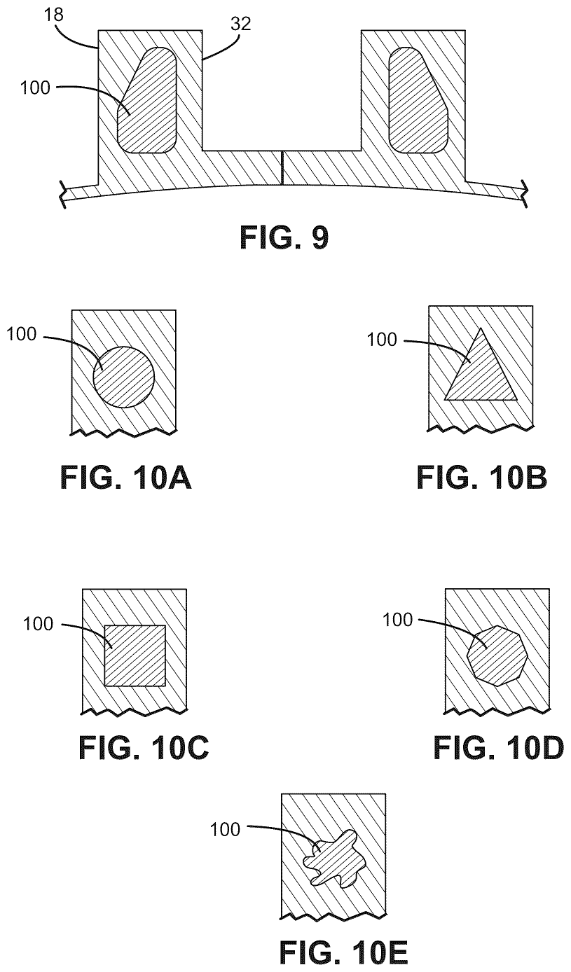

FIGS. 9-10E depict various embodiments of the nipple tip 18 in which the tip 18 has been reinforced with a reinforcement ring or structure 100. As best shown in FIG. 9, in this implementation, the wall 32 of the tip 18 has a substantially rigid ring or band 100 that is disposed within the wall 32 such that the ring 100 can maintain the shape of the tip 18 in case of compression during misuse and/or deviation from the suck-swallow-breath cycle associated with breastfeeding. In one embodiment, the ring 100 is made of a high durometer silicone or similar elastomer with rigidity similar to silicone with a hardness ranging from about 30 A to about 80 D. Alternatively, the ring 100 can be made of a hard polymer such as polypropylene having similar rigidity characteristics.

In certain embodiments, the ring 100 can have a cross-sectional shape as shown in FIG. 9 with a substantially flat inner surface (facing toward the interior of the tip 18) 102 and a curved outer surface (facing away from the interior of the tip 18) 104. Alternatively, as shown in FIG. 10A, the ring 100 can have a substantially circular cross-section. In a further alternative, as shown in FIG. 10B, the ring 100 can have a substantially triangular cross-section. According to another alternative, as shown in FIG. 10C, the ring 100 can have a substantially square cross-section. In yet a further alternative, as shown in FIG. 10D, the ring 100 can have a substantially hexagonal cross-section. Further, in another alternative as shown in FIG. 10E, the ring 100 can have a substantially random cross-section. According to further embodiments, the ring 100 can have any cross-sectional shape.

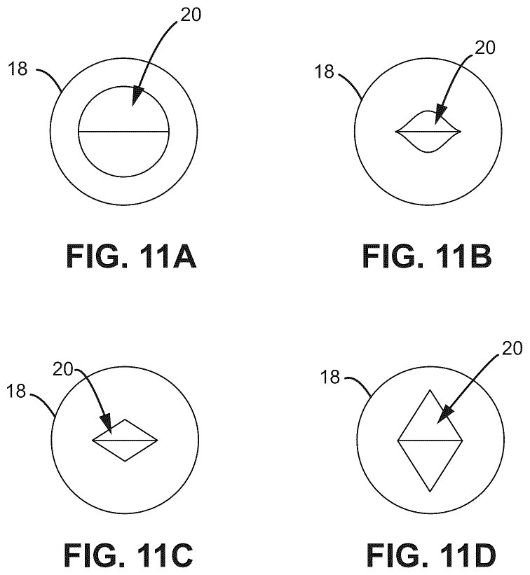

In accordance with certain embodiments, the cross-sectional shape of the lumen 20 of the nipple tip 18 can vary as well, as shown in FIGS. 11A-11D, for example. In FIG. 11A, the lumen 20 has a circular cross-section, while in FIG. 11B, the lumen 20 alternatively has an oval or oblong cross-section such that the slit 36 of the valve 22 at the bottom of the lumen 20 extends lengthwise from one end to the other end of the oblong-shaped lumen 20. Alternatively, in FIG. 11C, the lumen 20 has a diamond-shaped cross-section such that the slit 36 extends lengthwise from one end to the other end of the diamond-shaped lumen 20. In a further alternative, in FIG. 11D, the lumen 20 has a diamond-shaped cross-section such that the slit 36 extends crosswise from one side to the other side of the diamond-shaped lumen 20. One of skill in the art will further understand that the lumen 20 can have any other cross-sectional shape.

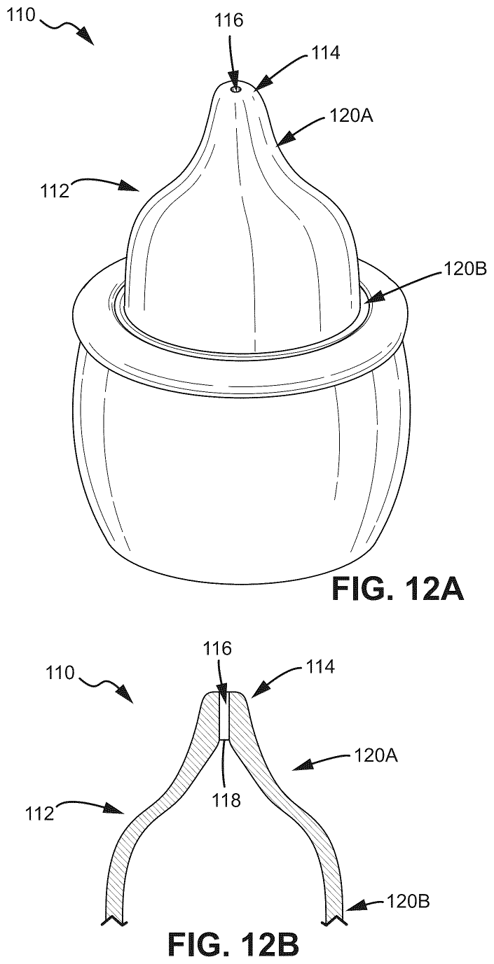

Another implementation of an infant bottle nipple 110 is depicted in FIG. 12A and FIG. 12B (discussed collectively herein). In this embodiment, the nipple 110 has a nipple body 112, a nipple tip 114 with a lumen 116 defined therethrough, and a valve 118 disposed within the lumen 116. The tip 114 and the valve 118 can be substantially similar to and operate in substantially the same way as any other embodiment disclosed or contemplated herein. In certain implementations, the wall 120 of the nipple body 112 has a distal section 120A near the nipple tip 114 that is flexible and a proximal section 120B that is thicker and more rigid than the distal section 120A. As such, the flexible section 120A can deform and thus can balloon within the infant's mouth when the infant is applying suction thereto, while the rigid section 120B is less deformable during use.

Additionally or alternatively, the bottle nipple 110 can be shaped to be oriented in a certain manner in an infant's mouth. That is, the bottle nipple 110 can have one or more cross section shapes that are configured to orient the nipple 110 in an infant's mouth. FIG. 12A shows such an embodiment. At the proximal end 120B, the nipple 110 can have an oval or elliptic cross section shape. At the distal end 120A, the nipple 110 can have a circular cross section shape. The oval cross section shape can be configured to generally follow the shape of an infant's mouth. While the embodiments herein depict a circular cross section at the distal end 120A and an oval cross section at the proximal end 120B, any cross-section shape may be used at both the proximal end 120B and distal end 120A.

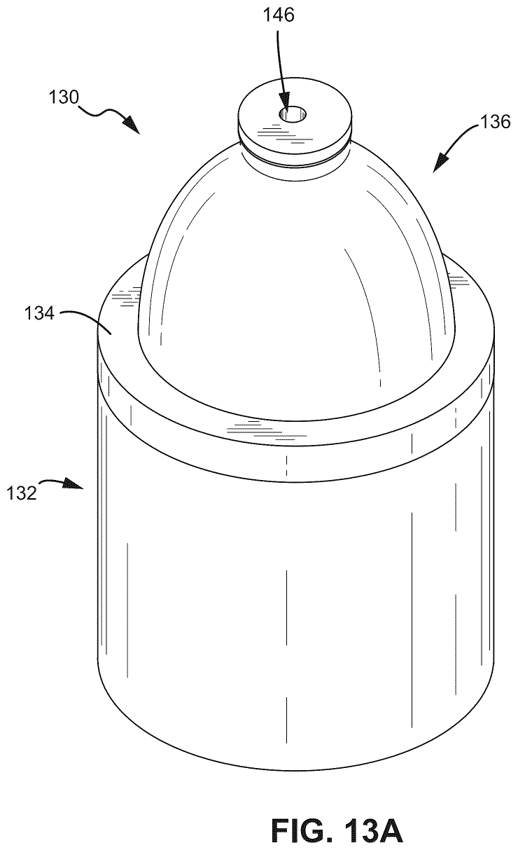

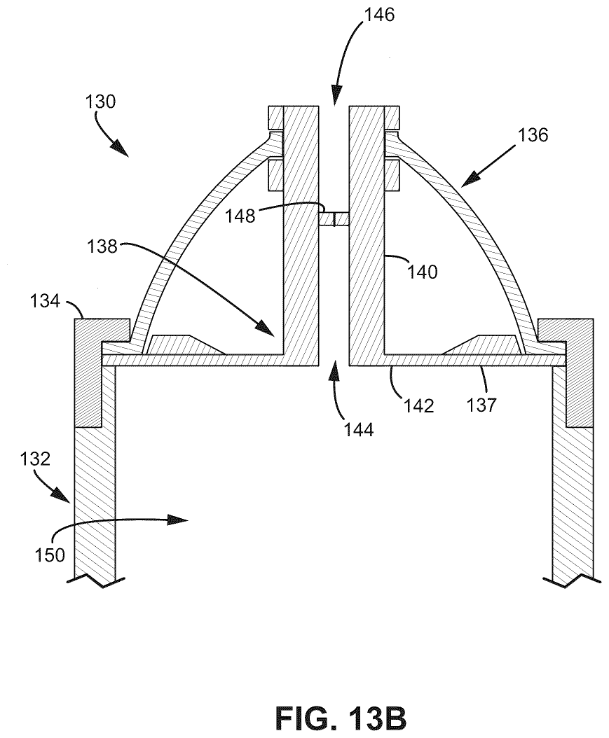

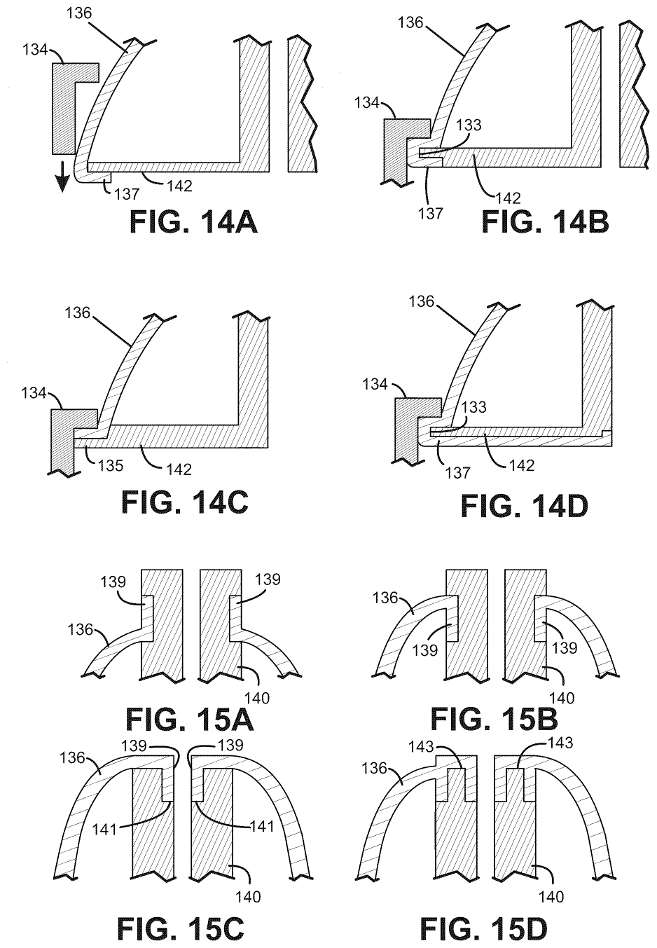

Yet another implementation of an infant bottle nipple 130 attached to a bottle 132 is depicted in FIGS. 13A-14D. In this embodiment, the nipple 130 is removably coupled to the bottle 132 via a threaded cap (or “connector”) 134. The nipple 130 can be disposed between the cap 134 and the bottle 132 such that the tightening of the cap 134 to the bottle 132 via the threads results in the nipple 130 being fixedly attached therebetween as shown via at least the base lip 137. The nipple 130 has a flexible nipple body 136 disposed around a substantially rigid internal frame 138 having an elongate tube 140 having a base or disk 142 attached to or integral with a proximal end of the tube 140. The tube 140 has a lumen 144 defined therethrough with an opening 146 at a distal end of the tube 140 and a valve 148 disposed within the lumen 144. The lumen 144 is in fluidic communication at its proximal end to the interior 150 of the bottle and further is in fluidic communication with an area external to the opening 146 at its distal end. The valve 148 can be any of the valve embodiments disclosed or contemplated herein. Further, the nipple 130 can have a pressure release valve or vent (not shown) substantially similar to the vent 28 discussed above with respect to FIG. 1A-1E.

Thus, the nipple 130 has two main components: the flexible body 136 that feels like a breast in the infant's mouth (and thus operates in a fashion substantially similar to the body 16 as discussed in detail above) and the substantially rigid internal frame 138 that provides additional rigidity to the nipple 130. In one embodiment, the internal frame 138 has a hardness ranging from about 30 A to about 50 D. In this embodiment, the lumen 144 connects the interior 150 of the bottle 132 to the opening 146 such that milk or formula can flow through the lumen 144 and the valve 148 (in a fashion substantially similar to that described above with respect to other embodiments) and out of the opening 146 into the infant's mouth. Thus, the nipple 130 embodiment can operate in a fashion substantially similar to the other nipple embodiments described herein and thus can be used in the same fashion as described above by an infant with the same benefits.

According to certain embodiments, the flexible body 136 can be coupled to the internal disk 142 of the internal frame 138 in a variety of ways. For example, FIGS. 14A-14D depict several different configurations for the attachment of the flexible body 136 and the internal disk 142. In some examples, such as that of FIG. 14A, disk 142 may be seated on base lip 137. The embodiment of FIG. 14B depicts the embodiment of FIG. 14A when cap 134 is coupled to the bottle (not pictured. The cap 134 can position flexible body 136 and internal disk 142 such that flexible body 136 forms reciprocating features configured to mate with one another. In this embodiment, the base lip 137 can be inwardly oriented, forming a channel 133 configured to receive the internal disk 142. Additionally or alternatively, wall 136 can be formed to include channel 133 prior to being fastened to a bottle with cap 134. FIG. 14C shows yet another implementation of coupling internal disk 142 to flexible body 136 wherein the internal disk 142 and flexible body 136 are flush against one another. In this example, the internal disk 142 can include a lip 135 configured to have the flexible body wall 136 seated thereon. FIG. 14D shows another implementation wherein lip 137 extends a length of internal disk 142 and forms an extended channel133 configured to receive the internal disk 142. In some embodiments, extended channel 133 can extend from the cap 134 to the lumen (not pictured). Alternatively, any known configuration can attach the flexible body 136 to internal disk 142.

Further, in accordance with various implementations, the flexible body 136 can be coupled to the elongate tube 140 of the internal frame 138 in a variety of ways. For example, FIGS. 15A-15D depict several different configurations for the attachment of the flexible body 136 and the elongate tube 140 as described in additional detail below. Alternatively, any other known attachment configuration can be used.

FIG. 15A shows an implementation of an internal frame 140 coupled to flexible body 136. In this implementation, internal frame 140 couples to a flexible body wall 139 extending away from the flexible body 136. Additionally or alternatively, the flexible body wall 139 can extend inward into flexible body 136, as shown in FIG. 15B. In another implementation, the internal frame 140 can include a seat 141 configured to receive a flexible body wall 139, as shown in FIG. 15C. In yet another implementation, internal frame 140 and flexible body 136 can include reciprocal features configured to mate with one another. In the example of FIG. 15D, the flexible body 136 can form a channel 143 configured to receive internal frame 140.

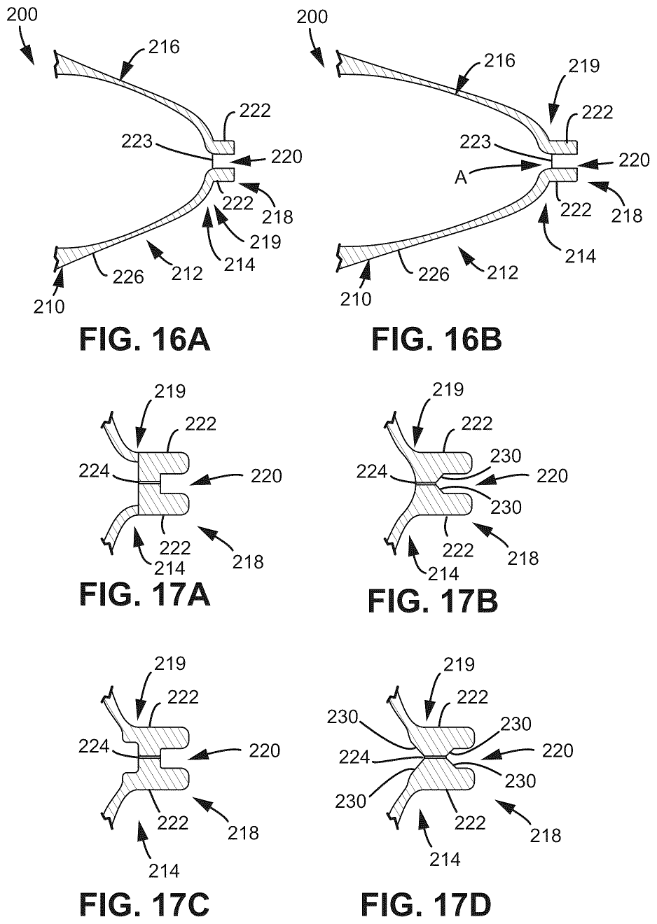

In various embodiments, the flexible body wall can be configured to deform in a manner similar to that of a human breast during breastfeeding. For example, FIG. 16A shows another implementation of the infant bottle nipple 200 including such a configuration. In this embodiment, flexible nipple body 216 is formed by wall 226. Thickness of wall 226 can vary from proximal wall section 210 to distal wall section 214 and/or where tip 218 is disposed on the bottle nipple 200. Distal wall section 214 can define a shoulder between body 216 and tip 218 and can, in some embodiments, form tip 218. In some embodiments, the thickness of the wall 226 can decrease between the proximal wall section 210 to the distal wall section 214 such that wall intermediate section 212 is thinner than proximal wall section 210 and distal wall section 214. This configuration can provide for more natural latching while supporting the bottle nipple.

An infant can latch onto the bottle nipple 200 at proximal wall section 210. Proximal wall section 210 can have a thickness that supports the infant latching at proximal wall section 210. For example, the proximal wall section 210 can have a thickness ranging from about 1 mm to about 3 mm. The distal wall section 214 thickness can range from about 2 mm to about 5 mm. Intermediate section 212 can have a thickness of less than about 1 mm. Nipple tip 218 can have an overall tip height h of about 7 mm to about 12 mm.

Bottle nipple 200 may be stretched during use as a result of the suction being applied by the user. FIG. 16B shows bottle nipple 200 of 16A undergoing such suction and thus being stretched in the direction shown via arrow A. Thus, during use of bottle nipple 200, bottle nipple tip 218 may pulled away from flexible nipple body 216, and, in some implementations, undergoes a displacement of about 1 mm to about 4 mm. As discussed above, the thickness at the distal section 214 may increase relative to intermediate section 212. The increase in thickness can support the nipple tip 218 during suction. Presence of a thicker distal section 214 relative to intermediate section 212 can also reduce deformity of nipple tip 218 that can occur due to stretching and/or other forces applied onto nipple tip 218.

Tip 218 can have an oval cross-section. In this embodiment, valve 223 can extend between walls 222 approximately the length of height h. Thus, compression of walls 222 can prevent compression of valve 223 as walls 222 may be compressed prior to valve 223 during use. This configuration can prevent misuse caused by said compression.

In some embodiments, increase in wall thickness at the distal portion 214 (such as the change in thickness discussed with respect to FIG. 12A and FIG. 12B) occurs at the proximal end 219 of tip 218. FIGS. 17A-17D show different possible valve 224 placements in a nipple tip 218 and how this placement can affect wall thickness. Valve 224 can be positioned at any location in lumen 220. Valve 224 can be any of the valve embodiments described herein. For example, as shown in FIG. 17A, valve 224 can be disposed in the tip 218 adjacent to the distal wall section 214 of the nipple body 216. In this example, the increase in thickness at the distal end 214 can occur at the valve 224. Valves 224 including a notch 230 may also be used, as shown in FIG. 17B. In this example, the increase in thickness can occur below valve 224. FIG. 17C shows another embodiment in which valve 224 is disposed at a height in the lumen 220 (such as the height described with respect to FIG. 8). In this example, the increase in thickness associated with the tip 218 can occur below the valve, such that distal end 214 of the body is, in part, defined by a proximal end 219 of the tip 218. In yet another embodiment, a valve 224 having a same or similar position to that of FIG. 17C may also include a plurality of notches 230, as shown in FIG. 17D. The increase in thickness at the distal end 214 may vary based on notch 230 placement in valve 224. However, these valve types and placements are illustrative and any valve described herein may be used, and the valves may or may not have any notch configuration described herein, and may be positioned at any location in lumen 220.

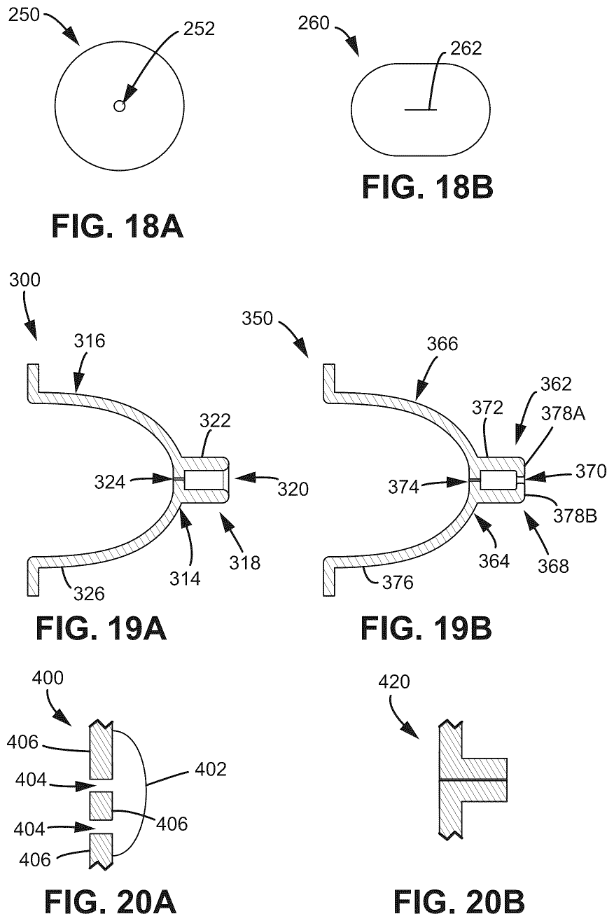

Embodiments having variable wall thickness can include nipple tips of various cross-section shapes. For example, tip 250 can have a circular cross-section, as shown in FIG. 18A. In other embodiments, tip 260 can have an elliptical cross-section, as shown in FIG. 18B. The cross-section of the tip can be any known shape.

Additionally or alternatively, the lumen of the mouthpiece can have a variety of configurations. For example, the lumen opening 252 can have a circular shape. In some embodiments, the lumen opening 252 can be smaller in width than the width of the valve (not pictured). In other implementations, the lumen can be defined by slit 262 and have an oval or elliptical cross-section shape. The cross-section of the lumen can be any known shape, and any lumen cross-section shape may be used with any tip cross-section shape.

The length of the nipple tip can influence its placement in an infant's mouth during use. FIG. 19A shows a cross-section of another implementation of a bottle nipple 300 wherein valve 324 is positioned in lumen 320 at a proximal portion 314 of tip 318. In such an embodiment, nipple tip 318 can have a length of about 5 mm to about 15 mm. It can be desirable to have a nipple tip having a length within said range, as a nipple tip having a length within this range can reduce the risk of misuse. During use, misuse can occur if a user compresses the nipple tip 318, which can cause valve 324 to open. As the length of the nipple tip 318 affects placement of tip 318 in an infant's mouth, position of valve 324 at proximal end 14 of a longer nipple tip 318 (in the range of about 5 mm to about 15 mm in length) can cause tip walls 322 to contact one another before opening of the valve, thereby reducing the amount of compressive force applied onto valve 324 and reducing misuse.

FIG. 19B shows a bottle nipple 350 including an elongate tip 368 (such as that of FIG. 19A) having additional features configured to prevent compression of tip 368. In some embodiments, the distal end 362 of nipple tip 368 can include an elbow structure 378 (compared to openings that do not include an elbow, such as that of FIG. 18A). Elbow structure 378 can include elbows 378A, 378B, which can be oriented to face one another radially around lumen 370. FIG. 19B is a cross-section of a bottle nipple 350 and depict elbows 378A, 378B as two structures; however, it should be understood that the elbows can be formed by a continuous elbow structure disposed radially around lumen 370 or can be multiple elbow structures disposed around the lumen 370. During use, the elbows 378A, 378B can be configured to prevent collapse of the nipple tip 368. Elbows 378A, 378B can add rigidity to nipple tip 368 and assist in maintaining the shape of the nipple tip 368 during use.

FIG. 20A and FIG. 20B show various valve configurations which may be used with bottle nipples comprising an elongate nipple tip, such as that of FIG. 20A and FIG. 20B. In some embodiments, such as that of FIG. 20A, an umbrella valve 400 may be used. During use, suction can cause umbrella 402 to raise from wall 406, allowing liquid to flow through openings 404. FIG. 20B shows an illustrative slit valve 420 which may be used, such as the valves discussed with respect to FIG. 4A-8. In other configurations, a duckbill valve or flap valve may be used. However, any known valve may be used. Each of these valves can be disposed at any height in the lumen, such as the placement described with respect to FIG. 6-8.

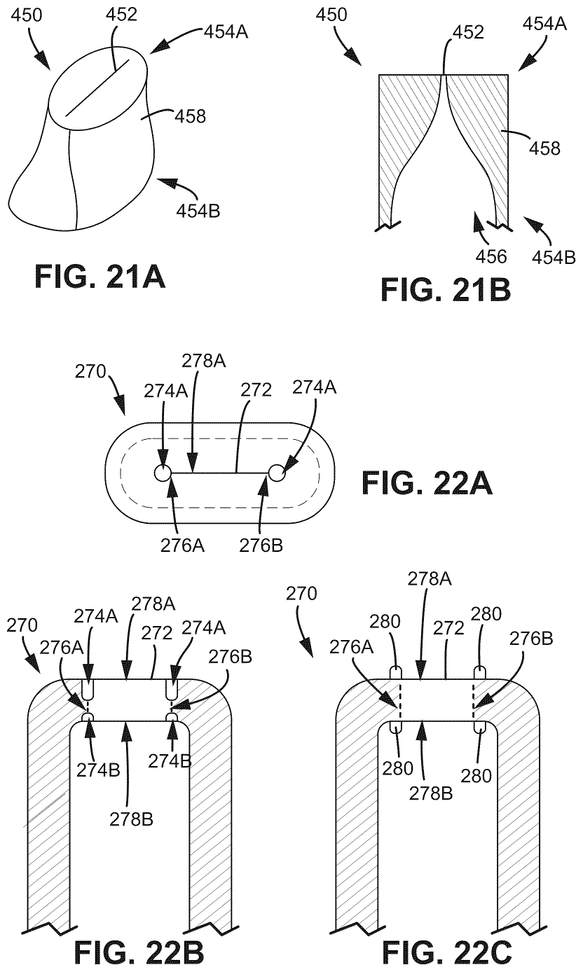

Some embodiments can include a slit that functions as a valve. FIG. 21A and FIG. 21B (discussed collectively) show another embodiment of nipple tip 450 including a slit 452. Slit 452 can be positioned at a distal end 454A of tip 450. Lumen 456 can be formed by tip wall 458 and extend from proximal end 454B to slit 452. Slit 452 can be configured to open and allow liquid to flow therethrough when a user applies suction thereto. The position of slit 452 in distal end 454A of tip 450 can prevent misuse. That is, compression of tip 450 causes compression of the slit 452, which further closes the slit 452, thereby preventing misuse. In such embodiments, an oval cross section shape may be used to orient slit 452 in an infant's mouth.

Additional features and/or structures may be incorporated into the nipple tip to reinforce said tip and/or prevent wear over time. FIGS. 22A and 22B (discussed collectively herein) show another implementation of a nipple tip 270 having an elliptic cross-section shape and a reinforced slit 272. Slit 272 can be reinforced using recesses 274A, 274B. First recesses 274A can be positioned at the first and second slit sides 276A, 276B at a first end 278A of slit 272, and second recesses 274B can be positioned at the first and second slit sides 276A, 276B at the second end 278B of slit 272. Recesses 274A, 274B do not extend from the proximal end 278B to the distal end 278A. Recesses 274A, 274B can range from about 0.1 mm to about 0.6 mm in depth. Recesses 274A, 274B can prevent tearing of slit 272.

In another embodiment, the nipple tip can include protrusions 280 at each end of the slit 272, instead of the recesses shown in FIG. 22A and FIG. 22B. These protrusions 280 are shown in FIG. 22C. The protrusions 280 can have a same or similar function and/or position as recesses 274A, 27B such that the protrusions 280 reinforce the slit ends 278A, 278B and prevent tearing of the slit 272. That is, protrusions 280 can extend outwardly from the slit 272 at the proximal and distal portions 278A, 278B of the slit 272 and at each side 276A, 276B of the slit 272.

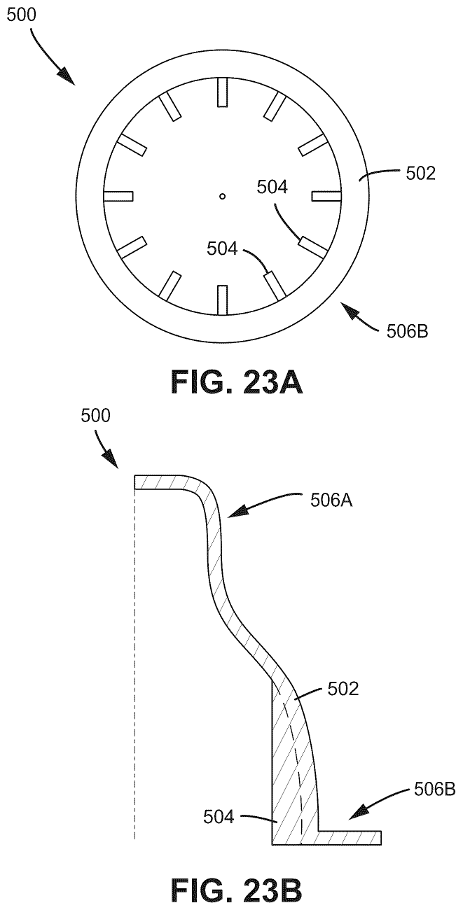

As discussed with respect to FIG. 13B, it may be desirable to reinforce the bottle nipple wall. However, in some embodiments, including embodiments using a slit (such as the embodiment shown in FIG. 21A and FIG. 21B), it may be desirable to reinforce the wall without having a structure at the tip. FIG. 23A and FIG. 23B (discussed collectively herein) show a structure 504 configured to reinforce bottle nipple 500. Some embodiments of bottle nipple 500 can include rib(s) 504 disposed on the interior of the flexible body wall 502. Ribs 504 can be radially disposed around the flexible body wall 502. As described with respect to FIG. 16A-16B, the flexible body wall 502 can have variable thickness ranging from proximal end 506B to distal end 506A. Ribs 504 can be included in embodiments wherein the wall 502 increases in thickness moving towards the proximal end 506B. Alternatively, ribs 504 can be used in embodiments including a wall 502 having a generally uniform thickness.

In some embodiments, ribs 504 can have a thickness ranging from about 1 mm to about 3 mm and the wall can have a thickness of about 1 mm to about 1.5 mm, such that the total combined thickness of the wall and rib ranges from about 3 mm to about 4 mm. The thickness of ribs 504 can be the distance the rib 504 protrudes from wall 502. The ribs can have a width ranging from about 1 mm to about 3 mm.

The embodiments herein may be manufactured in a variety of ways. For example, the infant bottle nipple tip may be injection molded.

It is understood that the various embodiments of infant bottle nipples and related methods and systems disclosed herein can be incorporated into or used with any other known feeding bottle devices, systems, and methods.

While the various systems described above are separate implementations, any of the individual components, mechanisms, or devices, and related features and functionality, within the various system embodiments described in detail above can be incorporated into any of the other system embodiments herein.

The terms “about” and “substantially,” as used herein, refers to variation that can occur (including in numerical quantity or structure), for example, through typical measuring techniques and equipment, with respect to any quantifiable variable, including, but not limited to, mass, volume, time, distance, wave length, frequency, voltage, current, and electromagnetic field. Further, there is certain inadvertent error and variation in the real world that is likely through differences in the manufacture, source, or precision of the components used to make the various components or carry out the methods and the like. The terms “about” and “substantially” also encompass these variations. The term “about” and “substantially” can include any variation of 5% or 10%, or any amount—including any integer—between 0% and 10%. Further, whether or not modified by the term “about” or “substantially,” the claims include equivalents to the quantities or amounts.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾ This applies regardless of the breadth of the range. Although the various embodiments have been described with reference to preferred implementations, persons skilled in the art will recognize that changes may be made in form and detail without departing from the spirit and scope thereof.

Although the various embodiments have been described with reference to preferred implementations, persons skilled in the art will recognize that changes may be made in form and detail without departing from the spirit and scope thereof.

While multiple embodiments are disclosed, still other embodiments will become apparent to those skilled in the art from the following detailed description, which shows and describes illustrative embodiments. As will be realized, the various implementations are capable of modifications in various obvious aspects, all without departing from the spirit and scope thereof. Accordingly, the drawings and detailed description are to be regarded as illustrative in nature and not restrictive.

What is claimed is:

1. A baby bottle nipple comprising:
(a) a flexible nipple body comprising a body wall;
(b) a nipple tip comprising:
(i) a tip wall that is more rigid than the body wall;
(ii) a lumen defined through the nipple tip; and
(iii) an opening disposed at a distal end of the nipple tip, the opening in fluidic communication with the lumen; and
(c) a valve disposed within the lumen such that the valve is disposed between an interior of the nipple body and the opening, wherein the valve comprises a closed configuration and an open configuration,
wherein the valve has a threshold cracking pressure to regulate flow, such that a non-negligible pressure differential is required to urge the valve into the open configuration.

2. The baby bottle nipple of claim 1, wherein the valve comprises a thin diaphragm having a slit.

3. The baby bottle nipple of claim 1, wherein the nipple body and the nipple tip are configured to simulate the shape, structure and consistency of a human breast.

4. The baby bottle nipple of claim 1, wherein the nipple body is configured to be pliable and stretchy such that the nipple body deforms between a roof of a baby's mouth, gums and tongue when a suction is applied thereto.

5. The baby bottle nipple of claim 1, wherein the body wall comprises:
(a) a proximal section having a proximal section thickness;
(b) an intermediate section having a an intermediate section thickness; and
(c) a distal section having a distal section thickness,
wherein the proximal section thickness is greater than the intermediate section thickness, and
wherein the proximal section is configured to be latched onto by a baby.

6. The baby bottle nipple of claim 5, wherein the proximal section thickness ranges from about 1 mm to about 3 mm.

7. The baby bottle nipple of claim 5, wherein the intermediate section thickness is less than 1 mm.

8. The baby bottle nipple of claim 5, wherein the distal section thickness ranges from about 2 mm to about 5 mm.

9. The baby bottle nipple of claim 5, wherein the nipple tip is disposed at the distal section of the body wall, and wherein the tip wall has a tip wall thickness ranging from about 1 mm to about 5 mm.

10. A baby bottle nipple comprising:
(a) a nipple body comprising a flexible body wall;
(b) a nipple tip comprising:
(i) a first end;
(ii) a second end opposite the first end; and
(iii) a tip wall forming a cavity extending from the first end to the second end, and
(c) a valve disposed within the cavity, the valve having an open configuration and a closed configuration,
wherein, in response to a non-negligible threshold pressure being applied to the valve by a mouth of a user, the valve is configured to move from the closed configuration into the open configuration.

11. The baby bottle nipple of claim 10, wherein:
the nipple body comprises a latching section configured for a user to latch onto during use,
the nipple tip is disposed on a distal end of the nipple body, and
when a user latches onto the latching section, the distal end of the nipple body is configured to be positioned in the user's mouth.

12. The baby bottle nipple of claim 11, wherein the nipple tip has a length ranging from about 5 mm to about 15 mm.

13. The baby bottle nipple of claim 11, wherein the latching section has a wall thickness of about 0.5 mm to about 3 mm, and wherein the nipple tip has a tip wall thickness of about 1 mm to about 5 mm.

14. The baby bottle nipple of claim 10, wherein the cavity extends from the first end of the nipple tip to the second end of the nipple tip, and wherein the valve is disposed in the cavity closer to the first end of the nipple tip than to the second end of the nipple tip.

15. The baby bottle nipple of claim 14, wherein the valve is configured to remain in the closed configuration when the tip wall is compressed by the user.

16. A baby bottle comprising:
(a) a bottle body comprising a wall, the wall forming a bottle body cavity configured to receive a liquid;
(b) a bottle nipple comprising:
(i) a nipple body comprising a flexible body wall;
(ii) a nipple tip comprising:
(A) a proximal end;
(B) a distal end having an opening; and
(C) a tip wall forming a tip cavity extending from the proximal end to the distal end, the tip cavity being in fluidic communication with the bottle body cavity and the opening, and
(iii) a valve disposed within the tip cavity, the valve having an open configuration and a closed configuration,
wherein the bottle nipple is operably coupled to the bottle body,
wherein, in response to a non-negligible threshold pressure being applied to the valve by a user, the valve is configured to move from the closed configuration into the open configuration, and
wherein the open configuration of the valve is configured to permit a flow of liquid from the bottle body cavity and through the tip cavity.

17. The baby bottle of claim 16, wherein the nipple body is configured to be pliable and stretchy such that the nipple body deforms between a roof of a baby 's mouth, gums and tongue when a suction is applied thereto by said baby.

18. The baby bottle of claim 16, wherein the nipple body comprises a latching section, and wherein the flexible body wall has a thickness ranging from about 1 mm to about 3 mm at the latching section.

19. The baby bottle of claim 16, wherein, in response to the nipple tip being compressed by a user, the tip wall is configured to be compressed at the opening and the valve is configured to remain in the closed configuration.

20. The baby bottle of claim 16, wherein the valve is disposed in the tip cavity closer to the proximal end of the nipple tip than to the distal end of the nipple tip.
